(19) United States
(12) Patent Application Publication
(10) Pub. No.: US 2008/0280155 A1
(43) Pub. Date: Nov. 13, 2008

(54) Method of Manufacture of Direct Pressure Laminates

(75) Inventors: Thomas Gerhard Willi Kronke, Velbert (DE); Monika Barbara Bischoff, Essen (DE); Alexandra Bruns, Essen (DE); Michael Guth, Duisburg (DE); Thomas Thews, Ludenscheid (DE); Detlef Andreas Wentzel, Essen (DE); Klaus-Dieter Hammer, Langenfeld (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Coveright Sufaces Holding GmbH, Essen (DE)

(21) Appl. No.: 11/911,051

(22) PCT Filed: Apr. 8, 2005
(86) PCT No.: PCT/EP2005/003725

§ 371 Date: Jun. 13, 2008

(51) Int. Cl. B32B 27/10; B32B 7/12; B31F 1/00

(52) U.S. Cl. 428/537.5; 156/327; 156/209

(57) ABSTRACT

Using a method of direct-pressure laminating employing short cycle presses (low pressure process), one or more impregnated overlays and a non-impregnated decor sheet are laminated to a base material.

### BACKGROUND OF THE INVENTION

The invention pertains to a method of manufacture of direct pressure laminates comprising at least one overlay, a decor sheet and an underlying base material in order to form a layered material, in particular a decorative surface. These materials are commonly used in the production of working surfaces, furniture components, panels or laminate flooring.

The manufacture of these layered materials can be performed in one-step (DPL—direct pressure laminating; CPL—continuous pressure laminating; HPL—high pressure laminating) processes. In a typical one-step process, the overlay and the decor sheet both are resin-impregnated and are laminated under pressure and heat in order to form a cover layer. The overlay, the decor sheet and the base material are at once—i.e. in a single step—laminated to form the final surface material. Thus, these processes involve only one laminating process, which renders to process in general time and cost efficient.

An example of a one-step direct pressure laminating process is known from DE 102 20 501, describing a process where both the overlay and the decor sheet are impregnated prior to laminating. Another example is given in US 2004/0038610, disclosing a direct laminating process with an operating pressure between 25 and 35 bar at temperatures up to 220° C.

Typical resin compositions for impregnating cover layers (overlay(s) and/or decor sheets) are melamine resins (melamine formaldehyde; MF). In contrast to previously used phenol formaldehyde (PF) resins, melamine resins have the advantage of a higher reactivity and diminished toxicity. An example for the manufacture of a melamine-based direct pressure laminate is given in DE 202 20 853, which describes a method of producing embossed-in-register building products.

So far, direct pressure laminating processes employing short cycle presses (low pressure process) always require a resin-impregnated decor sheet. This decor sheet can be laminated to an overlay, which may or may not be impregnated. However, if the overlay is not impregnated this may result in a final product with a lower surface quality. Thus, the favourable direct pressure laminating processes require a pre-step of impregnating the decor sheet and the overlay first. This requirement renders the commonly applied methods for manufacture of direct pressure laminates time consuming and thus also expensive.

### SUMMARY OF THE INVENTION

Therefore, it is the object of the invention to improve the direct pressure laminating process employing short cycle presses (low pressure process) in order to provide a process that is time and cost efficient, preferably without losing the desired surface quality of the finished laminate.

This object is solved by a laminating process wherein at least one impregnated overlay and a non-impregnated decor sheet are laminated to a base material in a single step (direct pressure laminating).

The main concept underlying the invention is that under heat and pressure resin from the overlay is partly transferred to the decor sheet and the base material in the laminating step, resulting in a final product with strongly interconnected layers. Thus, it is especially advantageous to impregnate the overlay over its saturation limit. Thus, the idea of the invention is that the excessive resin from the overlay will penetrate the decor sheet and therewith—simultaneously—connect it with the decor sheet and the base material employing short cycle presses. This process could be determined as a method of “press-impregnating”.

As outlined above, the method according to the invention requires the impregnation of the overlay only. Surprisingly, it was found that the final laminate produced employing short cycle presses is characterized by an optically homogeneous surface with a transparent and closed surface structure. Thus, the method according to the invention provides for a cost and time efficient way to produce high quality direct pressure laminates employing short cycle presses without a loss of surface quality.

In an advantageous embodiment of the invention, the resin/overlay composition has a flow value larger than 8%, preferably 8 to 30% and most preferably 10 to 20%. Preferably, these resin/overlay compositions have a content of volatile components between 6 and 8, in particular 6.9 and 7.4%. It is advantageous to use these resin/overlay compositions since due to their increased flow values their penetration through the decor sheet during the press impregnation process is enhanced. Thus, press lamination can be achieved with similar pressing times as compared with other direct pressure laminating processes employing short cycle presses. Using these resin/overlay compositions, it was found that with the direct pressure laminating according to the invention, the laminating process can be concluded within 20 and 30 seconds.

Standard resin/overlay compositions show flow values of 4.0 to 8.0% and are therefore less suited for the application in short cycle presses due to the not satisfying surface formation and the malfunctioning interconnection with the base material.

The flow values of the resin/overlay compositions can preferably be achieved by employing modifiers (“modified resins”). Such modifiers can be, but are not restricted to, di- and polyols, polyether diols and alkoxylated alcohols. The alkoxylated alcohols comprise methoxylated, ethoxylated and propoxylated alcohols, diols and polyols. Preferred compounds belong to the group of C₂ to C₁₂ diols, such as 1,4-butane diol, 1,5-pentane diol and 1,6-hexane diol. These diols preferably can be added in an amount of 8 to 20 weight parts per 100 parts resin.

The resin used may be an aminoplast resin, particularly a melamine resin.

The resin may comprise additives such as hardeners, surface-active agents, anti-foaming agents and separating agents. Preferred hardeners are sulfamic acid, ethanol amine hydrochloride, triethanol ammonium sulfate or hardener combinations such as morpholine/p-toluene sulfonic acid, N-methyl ethanol amine/SO₂ or N-methyl ethanol amine/ethanol amine/SO₂. The hardeners may be added to the impregnating procedure in amounts of 0.1 to 3% by weight. Surface-active agents can, for example, be ethoxylated fatty acids or alkyl phenol ethoxylates, which may be used in amounts between 0.2 and 1.0% by weight. Typical separating agents can be wax emulsions in amounts between 0.2 and 2.0% by weight. Possible anti-foaming agents may be weakly foaming special surfactant combinations in amounts between 0.1 and 1.0% by weight.

According to the invention, a resin-impregnated overlay and a non-impregnated decor sheet can be laminated to any base material, such as e.g. high density fibre boards (HDF), medium density fibre boards (MDF), chipboards, gypsum boards or glass fibre boards. Also, the method can be used to laminate resin-impregnated overlays and non-impregnated decor sheets to base materials covered by one or more kraft papers.

It can be advantageous to use a two-step process for impregnating the overlay, according to which the overlay is at first impregnated with a standard resin (flow value of 8% or below) and afterwards with a resin with a flow value larger than 8%, e.g. a resin comprising modifiers (see above). It can further be particularly advantageous to impregnate the overlay with a standard resin until the overlay has reached approximately twice its initial weight (without dying). Subsequently, the modified resin is added.

The overlays used preferably have a paper weight of less than 50 g/m², preferably 10 to 30 g/m², and can be impregnated with resin by weight percentages of 300 and 500%, in relation to the paper weight.

In a further embodiment of the invention, the impregnated overlay can be cured to a prepreg before being used for laminating. Doing so, the prepregs may be prepared and stored prior to being used in the laminating process.

Furthermore, as a further embodiment of the invention, the surface of the laminate can be furnished with a structure providing a decorative structure, such as wooden or stone surfaces; not only in colour, but also in shape.

In an especially preferred embodiment of the invention, the impregnated overlay and the decor sheet are laminated to the base material using a short cycle press. Preferred pressures are between 15 and 40 bar with temperatures between 140 and 220° C. Using these parameters, the pressing time required might be below 60 s.

### BRIEF DESCRIPTION OF THE DRAWING

None

### DETAILED DESCRIPTION OF PREFERRED EMBODIMENTS

### Examples

### Example 1

In a double impregnating process, an overlay sheet with a paper weight of 22 g/m² is preimpregnated in a first impregnating step with a standard melamine resin to reach a weight of 46 g. In a second step, the overlay is impregnated without intermediate drying with a standard melamine resin modified with 1,4-butane diol (8 parts by weight 1,4-butane diol per 100 parts melamine resin) to reach a final overlay weight of 122 g/m² and a content of volatile components of 7.3%. The resin composition has a flow value of 14.5%.

A 16 mm chipboard panel (size 50×50 cm²) is covered with a resin-free, printed decor sheet (paper weight 80 g/m²) and the above mentioned overlay and laminated in a short cycle press using a pressure of 20 bar, a temperature of 160° C. and a pressing time of 30 seconds.

The result shows an immaculate surface formation, i.e. an optically homogeneous, transparent and closed surface. The interconnection with the chipboard is acceptable and the covered product fulfils all technical demands.

### Example 2

In analogy to example 1, a 1,5-pentane diol modified overlay is produced. The standard melamine resin used in the second impregnating step is modified with 10 parts per weight 1,5-pentane diol per 100 weight parts melamine resin. The overlay has a weight after the first impregnation step of 45 g/m², a final weight of 120 g/m², and the resin has a content of volatile components of 6.9% and a flow value of 16.7%.

A 16 mm chipboard panel (size 50×50 cm²) is covered with a resin-free, printed decor sheet (paper weight 70 g/m²) and the above mentioned overlay and laminated in a short cycle press using a pressure of 25 bar, a temperature of 165° C. and a pressing time of 25 seconds.

The result shows a technically immaculate coating. The surface is optically homogeneous, closed and transparent. Interconnection malfunctions with the chipboard are not observable.

### Example 3

In analogy to example 1, a 1,6-hexane diol modified overlay is produced. The standard melamine resin used in the second impregnating step is modified with 15 parts per weight 1,6-hexane diol per 100 weight parts melamine resin. The overlay has a weight of 44 g/m² after the first impregnation step and a final weight of 120 g/m². The resin has a content of volatile components of 7.1% and a flow value of 17.1%,

A 16 mm chipboard panel (size 50×50 cm²) is covered with a resin-free, printed decor sheet (paper weight 90 g/m²) and the above mentioned overlay and laminated in a short cycle press using a pressure of 20 bar, a temperature of 170° C. and a pressing time of 20 seconds.

The result shows a faultless surface formation. The surface is optically homogeneous, transparent and closed. The interconnection with the chipboard is immaculate. The coating result meets all technical demands.

Determination of Flow Values:

To determine the flow value of the resin coated overlay, samples (size 10×10 cm²) are cut, weighed (=initial weight) and laminated between cold core plates in the flow press (T=160° C., p=20 bar, t=2 minutes). After the pressing process, the resin flown out of the overlay is separated from the overlay and its weight after pressing is determined (=output weight).

The flow value is determined using the following formula:

$$flow value [ \% ] = \frac{initial weight - output weight}{initial weight} \cdot 100$$

1. A method of direct-pressure laminating at least one impregnated overlay and a non-impregnated decor sheet to a base material employing short cycle presses (low pressure process).

2. A method as claimed in claim 1 using a resin/overlay composition with a flow value larger than 8%.

3. A method as claimed in claim 2, wherein the resin comprises at least one modifier for adjusting a flow value selected from the group consisting of di- or polyols, polyether dials and alkoxylated alcohols, and a mixture thereof.

4. A method as claimed in claim 3, wherein the modifier is selected from the group consisting of C₂ to C₁₂ diols.

5. A method as claimed in claim 2, wherein the resin is an aminoplast resin.

6. A method as claimed in claim 5, wherein the resin is a melamine resin.

7. A method as claimed in claim 2, wherein the resin comprises at least one additive selected from the group consisting of hardeners, surface-active agents, separating agents and anti-foaming agents.

8. A method as claimed in claim 1, wherein the base material is a material selected from the group consisting of high density fibre board (HDF), a medium density fibre board (MDF), a chipboard, a gypsum board, and a glass fibre board.

9. A method as claimed in claim 1, wherein at least one kraft paper is laminated to the base material.

10. A method as claimed in claim 1, wherein the at least one overlay is first impregnated with a standard resin and then with another resin to yield a resin/overlay composition with a flow value larger than 8%.

11. A method as claimed in claim 1, wherein the overlay has a paper weight of less than 50 g/m², and/or is impregnated with resin by weight percentages of 300 and 500%, in relation to the paper weight.

12. A method as claimed in claim 1, wherein the overlay is cured to a prepreg before being laminated to the decor sheet and the base material.

13. A method as claimed in claim 1, wherein a structure is imprinted in the laminating process.

14. A method as claimed in claim 1, employing a pressure of less than 40 bar.

15. A method as claimed in claim 1, employing a temperature lower than 220° C.

16. A laminate produced by a method as set forth in claim 1.

17. A method as claimed in claim 1 using a resin/overlay composition with a flow value from larger than 8% to 30%.

18. A method as claimed in claim 1 using a resin/overlay composition with a flow value of 10 to 20%.

19. A method as claimed in claim 4, wherein the modifier is selected from the group consisting of 1,4-butane diol, 1,5-pentane diol, and 1,6-hexane diol.

20. A method as claimed in claim 1, employing a pressure of less of 20 to 35 bar.

21. A method as claimed in claim 1, employing a temperature of 140 to 200° C.

22. A method as claimed in claim 2, wherein the resin/overlay composition have a content of volatile components between 6 and 8%.

23. A method as claimed in claim 2, wherein the resin/overlay composition have a content of volatile components between 6.9 and 7.4%.

24. A method as claimed in claim 3, wherein the modifier is added in an amount of 8 to 20 weight parts per 100 parts resin.
